(19) United States
(12) Patent Application Publication
(10) Pub. No.: US 2011/0305000 A1
(43) Pub. Date: Dec. 15, 2011

(54) DISPLAY SCREEN WITH LOW-INDEX REGION SURROUNDING PHOSPORS

(76) Inventors: Sergey A. Bukesov, Acton, MA (US); David Kindler, Concord, MA (US); John L. Ritter, Harvard, MA (US)

(21) Appl. No.: 13/155,317

(22) Filed: Jun. 7, 2011

Related U.S. Application Data
(60) Provisional application No. 61/353,185, filed on Jun. 9, 2010.

(51) Int. Cl. F21V 9/16

(52) U.S. Cl. 362/84

(57) ABSTRACT

A display screen having phosphor regions maximizes light leaving the phosphor regions using a gaseous, liquid or solid matter that is disposed between the light-producing phosphor regions and a divider member configured to separate the light-producing phosphor regions. The gaseous, liquid or solid matter may be air, a polymer, a gel, or other material that optically separates and has an index of refraction substantially less than the indices of refraction of the divider member and the light-producing phosphor regions.

### CROSS-REFERENCE TO RELATED APPLICATIONS

This application claims benefit of U.S. provisional patent application Ser. No. 61/353,185, filed Jun. 9, 2010, which is hereby incorporated herein by reference.

### BACKGROUND OF THE INVENTION

1. Field of the Invention

Embodiments of the present invention generally relate to display screens, and more specifically, to systems to improve brightness and color purity of such display screens.

2. Description of the Related Art

Electronic display systems are commonly used to display information from computers and other sources. Typical display systems range in size from small displays used in mobile devices to very large displays, such as tiled displays, that are used to display images to thousands of viewers at one time. Display systems generally rely on multi-colored pixel elements to form an image, where each pixel element may include one or more light-generating phosphors to produce the desired composite color and image intensity for a particular pixel of an image. Because brightness and contrast are important features of display systems, there is a need in the art for maximizing the delivery of light produced by each light-generating phosphor to a viewer, and for minimizing how much light from one light-generating phosphor bleeds into adjacent light-generating phosphors.

### SUMMARY OF THE INVENTION

One embodiment of the present invention sets forth a display device that maximizes light leaving light-emitting phosphor regions in the display device and minimizes bleeding of light emitted by one color of phosphor region into adjacent phosphor regions. A gaseous, liquid or solid material is disposed between the light-emitting phosphor regions and adjacent structural members. The gaseous, liquid or solid matter may be air, a polymer, a gel, or other material that optically separates the light-emitting phosphor regions and adjacent structural members, and has an index of refraction substantially less than the indices of refraction of the structural members and the light-producing phosphor regions.

One advantage of the present invention is that very little light emitted by the display device is absorbed by adjacent structural members separating the light-producing phosphor regions, and is instead reflected toward a viewer. Consequently, for a fixed input power level, the brightness of the display device is greater than that of a display device in which structural members absorb a significant portion of the light emitted by the light-producing phosphor regions. An additional advantage is that very little light emitted by each phosphor region in the display device is reflected, refracted, or otherwise scattered to unwanted regions in the display device. Thus, the color purity of images produced by the display device is maximized.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective schematic diagram of a display system, according to embodiments of the invention.

FIG. 2 is a partial cross-sectional view of a screen taken at section A-A in FIG. 1.

FIG. 3 is a magnified view of a gap as indicated in FIG. 2, according to embodiments of the invention.

FIG. 4 is a partial cross-sectional view of a display screen having a low-index gap disposed proximate a phosphor region and between structures of the display screen, according to embodiments of the invention.

FIG. 5 is a magnified view of a low-index gap indicated in FIG. 4, according to embodiments of the invention.

FIG. 6 is a schematic diagram of one configuration of a screen and a laser module in which a servo beam produces servo feedback light, according to embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

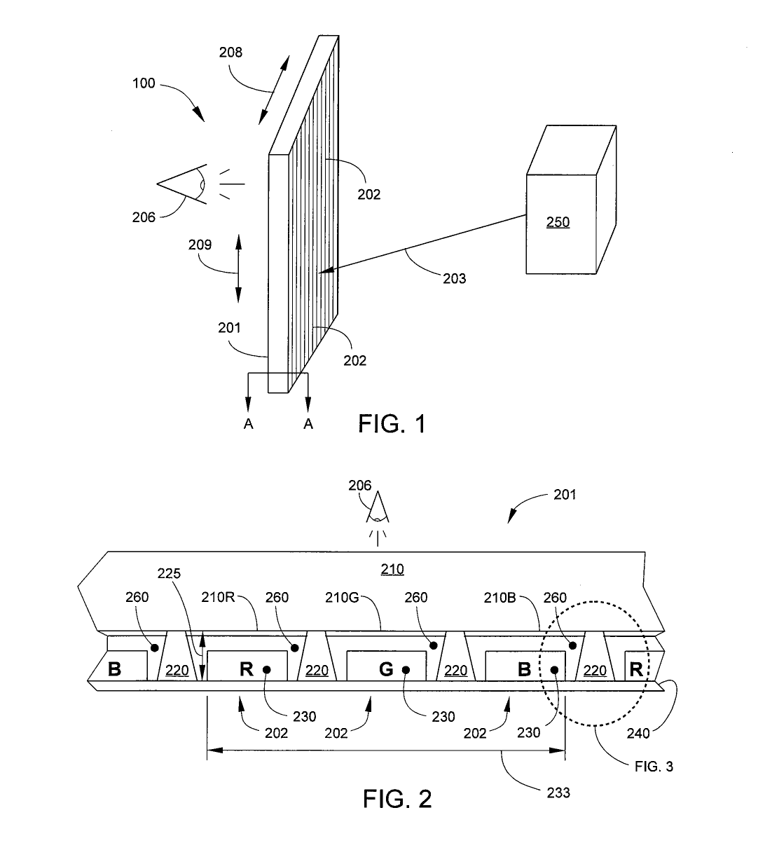

FIG. 1 is a perspective schematic diagram of a display system 100, according to embodiments of the invention. Display system 100 is a light-based electronic display device configured to produce video and static images for a viewer 206 using light-emitting phosphors. For example, display system 100 may be a laser-phosphor display (LPD), a light-emitting diode (LED) digital light processing (DLP), or other phosphor-based display device. In some embodiments, display system 100 is one of a plurality of display systems that are arranged to form a single tiled display screen.

Display system 100 has a screen 201 with phosphor stripes 202 and a laser module 250 that is used to produce one or more scanning laser beams 203 to excite the phosphor material on screen 201. Phosphor stripes 202 are made up of alternating phosphor stripes of different colors, e.g., red, green, and blue, where the colors are selected so that they can be combined to form white light and other colors of light. Scanning laser beam 203 is a modulated light beam that includes optical pulses that carry image information and is scanned across screen 201 along two orthogonal directions, e.g., horizontally (parallel to arrow 208) and vertically (parallel to arrow 209), in a raster scanning pattern to produce an image on screen 201 for viewer 206. In some embodiments, scanning laser beam 203 includes visible lasers beams of different colors that discretely illuminate individual pixel elements of screen 201 to produce an image. In other embodiments, scanning laser beam 203 includes invisible laser beams, such as near-violet or ultra-violet (UV) laser beams, that act as excitation beams to excite phosphors on the screen. In such embodiments, scanning laser beam 203 is directed to discrete pixel elements that are formed from phosphor stripes 202 or to portions of phosphor stripes 202 that act as discrete pixel elements and are made up of light-emitting material that absorbs optical energy from scanning laser beam 203 to emit visible light and produce an image. Alternatively, scanning laser beam 203 be comprised of hybrid visible and invisible lasers. For example, a blue laser can be used to generate blue color on screen 201, and the same blue laser could be used to excite phosphors that emit red and green light when excited. Alternatively, a UV laser may be used to excite phosphors that emit green light when excited, and a red and blue laser may be used to produce red and blue color directly on the screen.

FIG. 2 is a partial cross-sectional view of screen 201 taken at section A-A in FIG. 1. Screen 201 includes a color filter layer 210, phosphor regions 230 mounted on a thin transparent substrate 240, and standoff dividers 220. Color filter layer 210 is positioned on the side of screen 201 facing viewer 206, transparent substrate 240 is positioned on the opposite side of screen 201, and phosphor regions 230 are disposed between color filter layer 210 and transparent substrate 240 as shown.

Color filter layer 210 is a thin substrate, such as a 1 mm glass substrate, and may be configured with filter elements 210R, 210G, and 210B that each transmit light of one particular color. In some embodiments, color filter layer 210 is a structurally rigid or semi-rigid plate, and in other embodiments, color filter layer 210 is a relatively flexible substrate or sheet that is held in place by other structural elements of screen 201. In the embodiment illustrated in FIG. 2, color filter layer 210 includes red, green, and blue filter elements, which are positioned to align with a corresponding with red, green, or blue phosphor regions 230, denoted by R, G, and B, respectively. Filter elements 210R, 210G, and 210B may be formed with a lithographic process on the requisite portions of color filter layer 210 prior to the assembly of screen 201. In the embodiment illustrated in FIG. 2, filter elements 210R, 210G, and 210B are configured as elongated strips (perpendicular to page) that, like phosphor regions 230 and standoff dividers 220, extend vertically across screen 201, i.e., parallel to arrow 209 in FIG. 1.

Standoff dividers 220 separate phosphor regions 230 from each other and prevent color filter layer 210 from touching phosphor regions 230. Thus, standoff dividers 220 form a gap 260 around each of phosphor regions 230. One example material for standoff dividers 220 is a photosensitive resin. The photosensitive resin may be applied as an imageable photo-resist laminate to a substrate, such as color filter layer 201 or other planar structural member, and selectively exposed to the requisite light energy, such as UV light. When patterned appropriately, standoff dividers 220 can be formed in the desired regions on the substrate and the remainder of the photo-resist laminate removed. As shown, standoff dividers 220 may be formed to have walls that are angled, i.e., not normal to transparent substrate 240 or color filter layer 210. In some embodiments, standoff dividers 220 are configured as elongated strips positioned between phosphor regions 230. In one embodiment, standoff dividers 220, and therefore gap 260, have a height 225 of between about 50 and 100 μm.

Phosphor regions 230 are formed from phosphor stripes 202 and are configured to emit light of one color when excited by an excitation beam, such as scanning laser beam 203. Thus, each pixel element of screen 201 may include one or more phosphor regions 230, where each phosphor region 230 acts as a subpixel of a larger pixel element. In the embodiment illustrated in FIG. 2, one dimension of a pixel element, i.e., pixel width 233, is defined by the width of three phosphor regions 230, and the orthogonal dimension, i.e., out of the page, or vertical, is defined by the excitation laser beam spot size. In such an embodiment, because phosphor stripes 202 are continuous stripes, the vertical position of each pixel element is not fixed and may be selected as desired by adjusting the vertical position at which the excitation laser beam is directed to each phosphor stripe 202. In other embodiments, standoff dividers 220 may define both dimensions of each phosphor region 230, so that phosphor regions 230 are separated on all sides from adjacent phosphor regions by standoff dividers 220 formed in a grid pattern. In one embodiment, each of phosphor stripes 202 is spaced at a pitch of 500 μm to 550 μm, so that pixel width 233 of a pixel element on screen 201 is on the order of about 1500 μm. In other embodiments, each of phosphor stripes 202 is spaced at a pitch of about 180 μm to 220 μm, so that pixel width 233 of a pixel element on screen 201 is on the order of about 600 μm. In yet other embodiments, the pixel elements of screen 201 may include separate phosphor regions rather than portions of phosphor stripes 202. For example, each subpixel may be a discrete and isolated phosphor dot or rectangle of one particular light-emitting phosphor material.

Transparent substrate 240 is a thin, semi-rigid material that is transparent to UV and visible light and has an index of refraction that is relatively close to that of phosphor regions 230. Because the index of refraction of transparent substrate 240 is selected to be approximately equal to the index of refraction of phosphor regions 230, transparent substrate 240 and phosphor regions 230 are optically coupled, and light leaving phosphor regions 230 passes into transparent substrate 240 rather than reflects off the interface between transparent substrate 240 and phosphor regions 230. Other desirable characteristics for transparent substrate 240 include having a low coefficient of thermal expansion and low moisture absorption, and being readily manufacturable in thin layers. In addition, transparent substrate 240 is preferably comprised of a material that is not brittle and does not break-down with exposure to UV light and discolor over the lifetime of display system 100. In some embodiments, transparent substrate 240 comprises a polyethylene terephthalate (PET) film, which largely satisfies the above requirements. As described in greater detail below, the brightness of screen 201 is improved when transparent substrate 240 is configured as thin as practicable. In one embodiment, transparent substrate 240 comprises a PET film that is six microns or less in thickness.

Laser module 250 (shown in FIG. 1) forms an image on screen 201 by directing scanning laser beam 203 to phosphor stripes 202 and modulating scanning laser beam 203 to deliver a desired amount of optical energy to each phosphor region 230 of screen 201. Each phosphor region 230 outputs light for forming a desired image by the emission of visible light created by the selective laser excitation thereof by scanning laser 203. Some of the light emitted by phosphor region 230 will be incident on standoff dividers 220, which may absorb and/or transmit said light, depending on the material from which standoff dividers 220 are formed and the angle of incidence of the light with respect to the surfaces of standoff dividers 220. Transmission of incident light from phosphor region 230 into an adjacent phosphor region allows colors from different phosphor regions to mix, thereby degrading color purity of the image, while absorption of such light reduces the amount of light that ultimately reaches viewer 206. Embodiments of the invention contemplate the use of a material having a low-index of refraction that is disposed in gap 260 between phosphor regions 230 and standoff dividers 220. The presence of the low-index material in gap 260 minimizes the absorption and/or transmission by standoff dividers 220 of light emitted by phosphor regions 230, thereby allowing more of the light emitted by phosphor regions 230 to propagate through color filter layer 210 and reach viewer 206.

One advantage of having a low refractive index region, such as gap 260, disposed adjacent phosphor regions 230 is that material selection for standoff divider 220 can be greatly simplified. Since the reflectance of divider 220 for the possible wavelengths of emitted light 231 does not have to be considered, the material used for standoff divider 220 may be selected based on structural and other requirements, including strength, flexibility, and manufacturability.

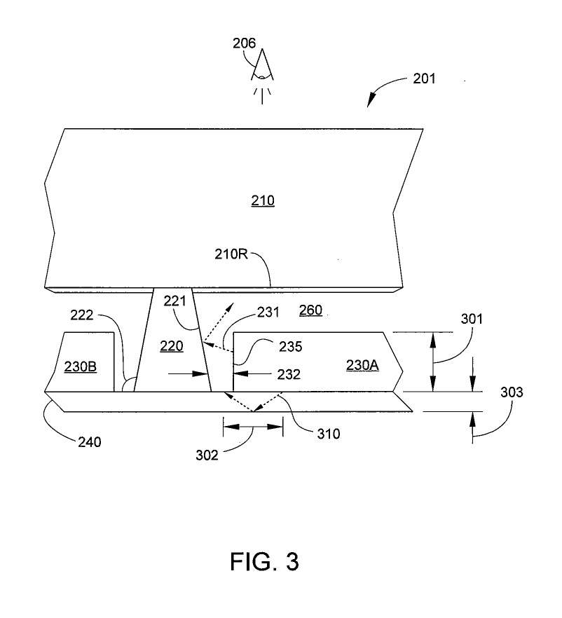

FIG. 3 is a magnified view of gap 260 as indicated in FIG. 2, according to embodiments of the invention. As shown, gap 260 is disposed between a phosphor region 230A, a standoff divider 220, and color filter layer 210. Gap 260 is a region of screen 201 that has a lower index of refraction than the indices of refraction of both phosphor region 230 and standoff divider 220 in order to minimize light absorbed and/or transmitted through standoff divider 220. Gap 260 may be an air-filled gap. Alternatively, gap 260 may be filled with a solid or semi-solid material having an appropriately low index of refraction with respect to phosphor regions 230 and standoff divider 220, such as a gel layer or a polymer. Because the matter that is filling gap 260 has a lower index of refraction than standoff dividers 220, nearly all emitted light 231 from phosphor region 230 that is incident on standoff divider 220 will be reflected rather than absorbed or transmitted through standoff divider 220. The only emitted light 231 striking standoff divider 220 that is absorbed or transmitted is emitted light 231 having an angle of incidence on a surface of standoff divider 220 that is greater than a threshold angle from the normal, where the threshold angle is generally only about 1 to 2 degrees. In addition, light entering gap 260 through gap 232, such as laser light from scanning laser beam 203, is more likely to be reflected from standoff divider 220 and eventually absorbed by phosphor region 230A. It is noted that gap 260 may be a relatively small gap compared to the dimensions of phosphor region 230 and standoff divider 220 and still function as desired. For example, as long as gap 232 is at least as great as one wavelength of emitted light 231, then emitted light 231 will reflect from standoff divider 220 as shown.

Image brightness of screen 201 is further enhanced because transparent substrate 240, when configured as a relatively thin structural element, can reduce how much light emitted by phosphor region 230A is transmitted to unwanted regions of screen 201. As shown in FIG. 3, a light ray 310 emitted by phosphor region 230A undergoes total internal reflection (TIR) when entering the material of transparent substrate 240. Thus, even though light ray 310 is initially emitted away from viewer 206 light ray 310 is redirected via TIR so that the return path of light ray 310 is toward viewer 206 and does not enter an adjacent subpixel. Light most likely to experience TIR inside the material of transparent substrate 240 generally has a directional component that is substantially parallel with transparent substrate 240, and consequently can be transmitted into unwanted regions of screen 201, such as into an adjacent standoff divider 220 or an adjacent phosphor region 230B. However, because transparent substrate 240 is configured as a structural element that is relatively thin with respect to thickness 301 of phosphor regions 230, the horizontal travel 302 of light ray 310 is relatively short, and therefore is less likely to be directed into an adjacent divider element 220 or other unwanted region of screen 201. In contrast, if transparent substrate 240 were configured with a greater thickness, e.g, with a thickness 303 substantially equal to thickness 301 of phosphor regions 230, horizontal travel 302 of light ray 310 is a significant fraction of the width of a phosphor region 230, thereby facilitating coupling of light ray 310 into an adjacent divider element 220 and the significant loss of light energy emitted from phosphor region 230. Thus, in some embodiments, thickness 303 of transparent substrate 240 is selected to be less than about one-third of thickness 301 of phosphor regions 230. In other embodiments, thickness 303 of transparent substrate 240 is selected to be as little as 6 microns or less.

In some embodiments, divider elements 220 are configured with sidewalls 221 that are not parallel with sidewalls 235 of phosphor regions 230. In such embodiments, only line contact can occur between sidewalls 221 and sidewalls 235 if, due to variations in manufacturing processes, gap 232 is not correctly formed between a divider element 220 and a phosphor region 230, and the divider element 220 and the phosphor region 230 are in contact with each other. If sidewalls 235 and 221 were parallel in such a scenario, optical coupling between the divider element 220 and the phosphor region 230 would readily occur, and a significant quantity of light emitted by the phosphor region 230 may be undesirably directed into the divider element 220. In some embodiments, sidewalls 221 may also be configured to reflect emitted light 231 from phosphor region 230 more directly toward viewer 206. For example, as shown in FIG. 3, sidewalls 221 are angled to form an obtuse angle with respect to transparent substrate 240 in order to reflect emitted light 231 more toward viewer 206 rather than into a center region of gap 260. In some embodiments, sidewalls 221 form a more obtuse angle than illustrated in FIG. 3. It is noted that as angle 222 increases, the width of divider standoff 220 also increases, thereby increasing the width of divider standoff 220 and effectively reducing the brightness of screen 201. Thus, there is a trade-off in increased brightness of screen 201 between reflecting more emitted light 231 with an increased angle 222 and reducing the width of divider standoff 220 with a reduced angle 222. One of skill in the art, upon reading the disclosure provided herein, can readily optimize angle 222 for maximum brightness of screen 201.

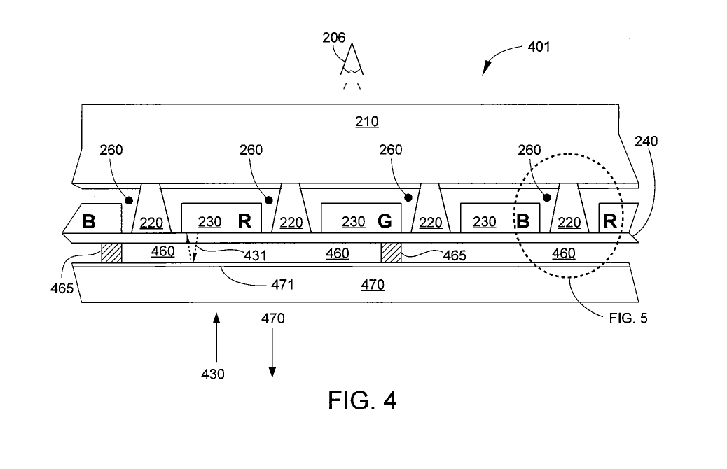

In some embodiments, a display screen is configured to direct more light emitted by phosphor regions in the screen toward viewer 206 via a low index of refraction region disposed proximate the phosphor regions. FIG. 4 is a partial cross-sectional view of a display screen 401 having a low-index gap 460 disposed proximate phosphor region 230 and between structures of display screen 401, according to embodiments of the invention. Display screen 401 is substantially similar in organization and operation to screen 201, described above, with the addition of a reflector layer 470 and a low-index gap 460 disposed between reflector layer 470 and transparent substrate 240.

Low-index gap 460 is a region of screen 401 that has a lower index of refraction than surrounding structures of screen 401 in order to minimize light absorbed and/or transmitted away from viewer 206. In the embodiment illustrated in FIG. 4, low-index gap 460 is disposed between transparent substrate 240 and reflector layer 470, and has an index of refraction substantially lower than the indices of refraction of transparent substrate 240 and reflector layer 470. Low-index gap 460 may be an air-filled gap, or may be filled with a solid or semi-solid material having an appropriately low index of refraction with respect to transparent substrate 240 and reflector layer 470, such as a gel layer or a polymer. As described above with respect to gap 260 and standoff dividers 220, because the matter that is filling low-index gap 460 has a lower index of refraction than reflector layer 470, nearly all emitted light 431 from phosphor regions 230 that is incident on reflector layer 470 will be reflected rather than absorbed or transmitted through reflector layer 470. In addition, because reflector layer 470 includes a reflecting material 471, described below, even incident emitted light 431 that is substantially normal to the surface of reflector layer 470 will be reflected back toward viewer 206, thereby enhancing the brightness of screen 401.

Reflector layer 470 is a thin substrate, such as a glass substrate, that acts as a structural layer of screen 401, reflects visible and UV light toward phosphor regions 230 and viewer 206, and is spaced from transparent substrate 240 to define low-index gap 460. In one embodiment, reflector layer 470 is a structurally rigid substrate, and includes a reflector material 471, such as a multi-layer optical film, that transmits UV light traveling in direction 430 and reflects UV and visible light traveling in direction 440. Thus, reflector layer 470 allows UV light contained in scanning laser beam 203 can to enter the subpixels of screen 401, while reflecting emitted light 431 and UV light that has not been absorbed by phosphor regions 230 and is scattering inside screen 401. In one embodiment, reflector material 471 is a very thin, co-extruded film. More specifically, multiple sheets of films with different refractive indices may be laminated or fused together to construct a composite sheet as a dichroic layer. In some implementations, multiple layers of two different materials with different indices may be used to form a composite film stack by placing the two materials in an alternating manner. In other implementations, three or more different materials with different indices may be stacked together to form the composite film stack. Such a composite sheet for a dichroic layer is essentially an optical interference reflector that transmits the excitation light (e.g., UV light) that excites the phosphor materials which emit colored visible light and reflects the colored visible light. A composite sheet for a second dichroic layer may be complementary to the first dichroic layer: transmitting the colored visible light emitted by the phosphors and reflecting the excitation light (e.g., UV light). Such composite sheets may be formed of organic, inorganic or a combination of organic and inorganic materials. The multiple-layer composite sheet may be rigid or flexible. A flexible multi-layer composite sheet may be formed from polymeric, nonpolymeric materials, or polymeric and non-polymeric materials. Exemplary films including a polymeric and non-polymeric material are disclosed in U.S. Pat. Nos. 6,010,751 and 6,172,810 which are incorporated by reference in their entirety as part of the specification of this application. An all-polymer construction for such composite sheets may offer manufacturing and cost benefits. If high temperature polymers with high optical transmission and large index differentials are utilized in the of an interference filter, then an environmentally stable filter that is both thin and very flexible can be manufactured to meet the optical needs of short-pass (SP) and (LP) filters. In particular, coextruded multilayer interference filters as taught in U.S. Pat. No. 6,531,230 can provide precise wavelength selection as well as large area in a very thin cost effective manufacturing composite layer set. The entire disclosure of U.S. Pat. No. 6,531,230 is incorporated by reference as part of the specification of this application. The use of polymer pairs having high index differentials allows the construction of very thin, highly reflective mirrors that are freestanding, i.e. have no substrate but are still easily processed for constructing large screens. Such a composite sheet is functionally a piece of multi-layer optical film (MOF) and includes, e.g., alternating layers of PET and co-PMMA to exhibit a normal-incidence reflection band suitable for the screen applications of this application. As an example, an enhanced specular reflector (ESR) made out of a multilayer polyester-based film from 3M Corporation may be configured to produce the desired dichroic reflection and transmission bands for the present application. Examples for various features of multi-layer films are described in U.S. Pat. No. 5,976,424, U.S. Pat. No. 5,080,467 and U.S. Pat. No. 6,905,220, all of which are incorporated by reference as part of the specification of this application.

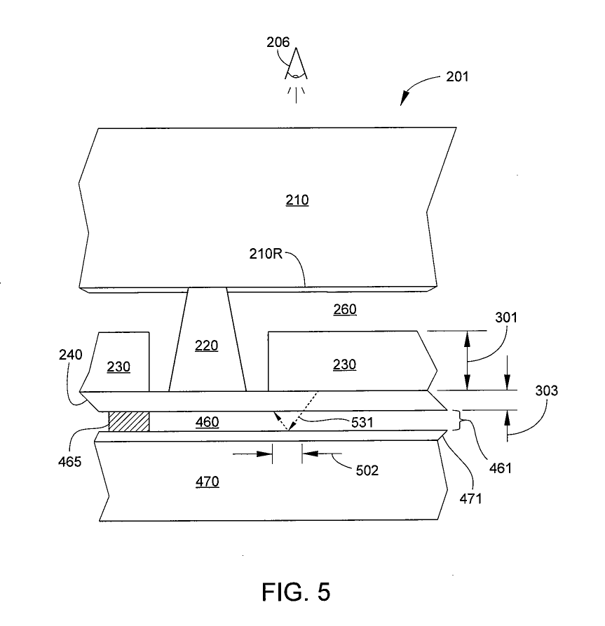

The thickness 461 (shown in FIG. 5) of low-index gap 460 is defined by one or more stand-off elements 465 positioned between reflector layer 470 and transparent substrate 240. Thickness 461 may be as great as thickness 301 of phosphor regions 230 or as small as one wavelength of emitted light 431. In order to minimize horizontal travel of emitted light 431, thickness 461 is made as small as practicable. The beneficial effect of a very narrow low-index gap 460 is illustrated in FIG. 5. FIG. 5 is a magnified view of low-index gap 460 as indicated in FIG. 4, according to embodiments of the invention. As illustrated by ray 531, when low-index gap 460 is relatively narrow, e.g., substantially thinner than thickness 301 of phosphor regions 230, horizontal travel 502 of ray 531 in low-index gap 460 is minimized, even when ray 531 has a directional component that is substantially parallel to reflector layer 470. Consequently, very little emitted light 431 is directed to unwanted regions of screen 401, such as into standoff dividers 220. This is true even for emitted light 431 leaving a phosphor region 230 in a direction substantially parallel to reflector layer 470. Thus, with virtually no emitted light 431 being optically coupled to standoff dividers 220, the color purity of screen 401 is improved, since colored light from one phosphor region 230 does not bleed into adjacent phosphor regions 230. And because virtually all emitted light 431 exits screen 201 on the viewer side regardless of initial direction radiated from the phosphor regions 230, image brightness off of screen 401 is also improved. Further, a narrow configuration of low-index gap 460 facilitates more UV or other excitation light to strike a desired phosphor and generate more visible light exiting on the viewer side 206, since such excitation light is more likely to reflect within the desired sub-pixel phosphor until absorbed by phosphor particles within region 230 in the sub-pixel.

Standoff elements 465 are spacing members configured to define and maintain the uniformity and thickness of low-index gap 460. Standoff element 465 are comprised of a material transparent that is to visible and UV light and remains dimensionally stable under the pressures found in screen 401. Other desirable characteristics of standoff elements 465 include low moisture absorption and resistance to optical and mechanical break-down under prolonged exposure to UV light.

In some embodiments, standoff elements 465 are positioned randomly with respect to phosphor regions 230 to prevent patterning effects and other visible artifacts from being visible to viewer 206. In other embodiments, standoff elements 465 are positioned in specific regions of low-index gap 460 in which the presence of such structural elements is less likely to be detected by viewer 206. For example, in some embodiments, standoff elements 465 are positioned only adjacent to blue phosphor regions 230, since green light is aligned with human eye photoptic peak and variation in green light caused by standoff elements 465 are more easily detected. In other embodiments, standoff elements 465 are positioned adjacent standoff dividers 220, since standoff dividers 220 are regions in which little light is emitted anyway. In some embodiments, standoff elements 465 may also be configured as structural members of screen 401 in order to enhance cohesion of the various layers making up screen 401. In some embodiments, standoff elements 465 may include an adhesive coating in order to mechanically couple reflector layer 470 to transparent substrate 240.

Display system 100 is depicted as an LPD in FIGS. 1-5, however other light-based electronic display devices may also benefit from embodiments of the invention if configured to produce an image using light-emitting phosphors.

In some embodiments, a display system includes servo control mechanisms based on a servo beam that is scanned over the screen by the same optical scanning components that scan scanning laser beams 203 across screen 201. This servo beam is used to provide servo feedback control over the scanning excitation beams, i.e., scanning laser beams 203, to ensure proper optical alignment and accurate delivery of optical pulses during normal operation of display system 100. In such an embodiment, the servo beam is at a different wavelength of light than scanning laser beams 203, e.g., the servo beam may be an infra-red (IR) beam, and screen 201 is configured to reflect the servo beam to produce servo feedback light.

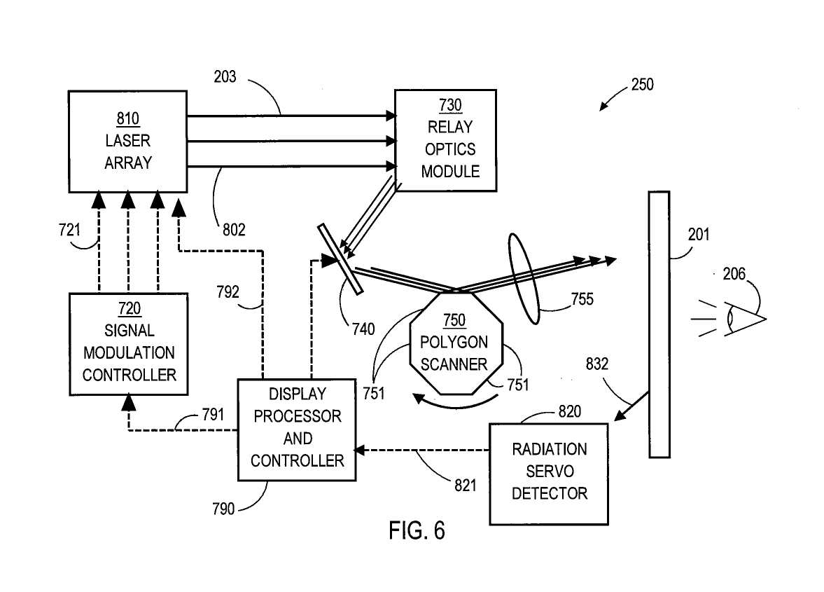

FIG. 6 is a schematic diagram of one configuration of screen 201 and laser module 250 in which a servo beam 703 produces servo feedback light 832, according to embodiments of the invention. Laser module 250 includes a signal modulation controller 720, a laser array 810, a relay optics module 730, a mirror 740, a polygon scanner 750, an imaging lens 755, and a display processor and controller 790, and one or more radiation servo detectors 820 configured as shown.

Some implementations of laser-based display techniques and systems described here use at least one scanning laser beam to excite color light-emitting materials deposited on a screen to produce color images. The scanning laser beam is modulated to carry images in red, green and blue colors or in other visible colors and is controlled in such a way that the laser beam excites the color light-emitting materials in red, green and blue colors with images in red, green and blue colors, respectively. Hence, the scanning laser beam carries the images but does not directly produce the visible light seen by a viewer. Instead, the color light-emitting fluorescent materials on the screen absorb the energy of the scanning laser beam and emit visible light in red, green and blue or other colors to generate actual color images seen by the viewer.

Laser array 810 includes multiple lasers, e.g., 5, 10, 20, or more, and generates multiple scanning laser beams 203 to simultaneously scan screen 201. In addition, laser array 810 includes a laser diode for generating a servo beam 802, which provides servo feedback control over scanning laser beams 203. In one embodiment, the lasers in laser array 810 are ultraviolet (UV) lasers producing light with a wavelength between about 400 nm and 450 nm.

Signal modulation controller 720 controls and modulates the lasers in laser array 810 so that scanning laser beams 203 are modulated at the appropriate output intensity to produce a desired image on screen 201. Signal modulation controller 720 may include a digital image processor that generates laser modulation signals 721. Laser modulation signals 721 include the three different color channels and are applied to modulate the lasers in laser array 810. In some embodiments, the output intensity of the lasers is modulated by varying the input current or input power to the laser diodes.

Together, relay optics module 730, mirror 740, polygon scanner 750, and imaging lens 755 direct scanning laser beams 203 and servo beam 802 to screen 201 and scan said beams horizontally and vertically across screen 101 in a raster-scanning pattern to produce an image. Relay optics module 730 is disposed in the optical path of scanning laser beams 203 and servo beam 802 and is configured to shape scanning laser beams 203 to a desired spot shape and to direct scanning laser beams 203 into a closely spaced bundle of somewhat parallel beams. Mirror 740 is a reflecting optic that can be quickly and precisely rotated to a desired orientation, such as a galvanometer mirror, a microelectromechanical system (MEMS) mirror, etc. Mirror 740 directs scanning laser beams 203 and servo beam 802 from relay optics module 730 to polygon scanner 750, where the orientation of mirror 740 partly determines the vertical positioning of scanning laser beams 203 and servo beam 802 on screen 201. Polygon scanner 750 is a rotating, multi-faceted optical element having a plurality of reflective surfaces 751, e.g., 5 to 10, and directs scanning laser beams 203 and servo beam 802 through imaging lens 755 to screen 201. The rotation of polygon scanner 750 sweeps scanning laser beams 203 horizontally across the surface of screen 201 and further defines the vertical positioning of scanning laser beams 203 on screen 201. Imaging lens 755 is designed to direct each of scanning laser beams 203 onto the closely spaced pixel elements on screen 201. In operation, the positioning of mirror 740 and the rotation of polygon scanner 750 horizontally and vertically scan scanning laser beams 203 and servo beam 802 across screen 201 so that all pixel elements of screen 201 are illuminated as desired.

Display processor and controller 790 is configured to perform control functions for and otherwise manage operation of laser module 250 and display system 100. Such functions include receiving image data of an image to be generated, providing an image data signal 791 to signal modulation controller 720, providing laser control signals 792 to laser array 810, producing scanning control signals for controlling and synchronizing polygon scanner 750 and mirror 740, and performing calibration functions.

Display processor and controller 790 may include one or more suitably configured processors, including a central processing unit (CPU), a graphics processing unit (GPU), a field-programmable gate array (FPGA), an integrated circuit (IC), an application-specific integrated circuit (ASIC), or a system-on-a-chip (SOC), among others, and is configured to execute software applications as required for the proper operation of display system 100. Display processor and controller 790 may also include one or more input/output (I/O) devices and any suitably configured memory for storing instructions for controlling normal and calibration operations, according to embodiments of the invention. Suitable memory includes a random access memory (RAM) module, a read-only memory (ROM) module, a hard disk, and/or a flash memory device, among others.

In the embodiment illustrated in FIG. 6, screen 201 includes reflective servo reference marks 850 disposed on screen 201 which reflect servo beam 802 away from screen 201 as servo feedback light 432. The one or more radiation servo detectors 820 detect servo feedback 832 and direct servo detection signals 821 to display processor and controller 790 for processing. An LPD-based display system configured with a servo beam is described in greater detail in U.S. Patent Application Publication No. 2010/0097678, entitled “Servo Feedback Control Based on Designated Scanning Servo Beam in Scanning Beam Display Systems with Light-Emitting Screens” and filed Dec. 21, 2009, and is incorporated by reference herein.

In sum, embodiments of the present invention set forth a display device that maximizes light leaving light-emitting phosphor regions in the display device and minimizes bleeding of light emitted by one color of phosphor region into adjacent phosphor regions that are emitting a different color of light. Advantages of the present invention include increased brightness and enhanced color purity of a display screen.

While the foregoing is directed to embodiments of the present invention, other and further embodiments of the invention may be devised without departing from the basic scope thereof, and the scope thereof is determined by the claims that follow.

1. A display device comprising:
an optical module that includes one or more lasers producing excitation light of one or more optical excitation beams modulated to carry optical pulses carrying images and scans the excitation light onto the display screen in a two dimensional pattern to direct the optical pulses at different locations on the display screen to display the images;
a display screen comprising a plurality of phosphor regions; and
divider members configured to separate the phosphor regions,
where the excitation light enters the first display screen side and light from the phosphor regions is emitted from the second display screen side;
where a first region isolating a first and second divider member from a phosphor region;
where the phosphor region is between the first and second divider members;
where, the first region having an index of refraction substantially less than indices of refraction of the divider members and the phosphor region.

2. The display device of claim 1, wherein the first region includes one of a vacuum, a gas, a polymer, and a gel.

3. The display device of claim 1, further comprising a first transparent layer, wherein the first region is disposed between the adjacent divider members, the phosphor region, and the first transparent layer.

4. The display device of claim 3, wherein the first transparent layer comprises a substrate configured as a color-filter layer.

5. The display device of claim 3, wherein a first portion of the first region is disposed between the phosphor region and the first transparent layer.

6. The display device of claim 3, further comprising a transparent substrate on which the phosphor regions are mounted.

7. The display device of claim 6, further comprising a stand-off element positioned to define a second region between the phosphor region and a second layer, the second region having an index of refraction substantially less than indices of refraction of the second layer and the phosphor region.

8. The display device of claim 1, further comprising a stand-off element positioned to define a second region between the phosphor region and a second layer, the second region having an index of refraction substantially less than indices of refraction of the second layer and the phosphor region.

9. The display device of claim 8, wherein the stand-off element is positioned adjacent the phosphor region.

10. The display device of claim 8, wherein the stand-off element is positioned adjacent one of the plurality of divider members.

11. The display device of claim 8, wherein the second region is defined between the second layer, the phosphor region adjacent to the stand-off element, and at least one phosphor region that is not adjacent to the stand-off element.

12. The display device of claim 8, wherein the second region includes one of a vacuum, a gas, a polymer, and a gel.

13. The display device of claim 8, wherein the second layer comprises a reflector layer configured to reflect visible light emitted by the plurality of phosphor regions.

14. The display device of claim 8, wherein a thickness of the second region is less than a thickness of the phosphor regions.

15. The display device of claim 8, wherein the plurality of stand-off elements are positioned randomly with respect to the phosphor regions.

16. The display device of claim 8, wherein the plurality of stand-off elements are disposed adjacent one or more blue phosphor regions.

17. The display device of claim 8, wherein the stand-off elements comprise elongated strips.

18. The display device of claim 8, wherein the stand-off elements comprise an adhesive configured to mechanically couple layers of the display device.

19. The display device of claim 1, wherein the divider members comprise elongated strips.

20. The display device of claim 1, further comprising a transparent substrate on which the phosphor regions are mounted.

21. The display device of claim 20, wherein the transparent substrate is substantially transparent to visible and ultra-violet light.

22. The display device of claim 20, wherein a thickness of the transparent substrate is less than about one-third a thickness of the phosphor regions.

23. The display device of claim 20, wherein the transparent substrate comprises a polyethylene terephthalate (PET) film.

24. The display device of claim 20, wherein the transparent substrate is porous.
